(19) United States
(12) Patent Application Publication
(10) Pub. No.: US 2026/0291927 A1
(43) Pub. Date: Sep. 24, 2026

(54) BOT ACCESS PREVENTION DATA USED FOR COLLECTIVE SUPERVISED LEARNING OF UNSTRUCTURED DATA

(71) Applicant: Wells Fargo Bank, N.A., San Francisco, CA (US)

(72) Inventors: Niladri Bhattacharya, Livingston, NJ (US); Frank H. Dix, New York, NY (US); Michael Charles Reynolds, Avon, CT (US)

(21) Appl. No.: 19/086,812

(22) Filed: Mar. 21, 2025

(51) Int. Cl. H04L 9/40

(52) U.S. Cl. CPC H04L 63/08

(57) ABSTRACT

Systems and techniques may generally be used for presenting a login challenge and using results of the login challenge as a label for unstructured data. An example technique may include receiving a login request, presenting, in response to receiving the login request, a user interface, the user interface including unstructured data, and receiving, via the user interface, data classification information related to the unstructured data, via the user interface. The example technique may include verifying that the login request was generated by a human using the data classification information, and allowing, in response to verifying that the login request was generated by a human, the login request to proceed. The data classification information may be output as a label of the unstructured data. In some examples, the label or the unstructured data may be used to train a machine learning model.

### BACKGROUND

Online services and platforms face ongoing challenges in preventing automated bot access while maintaining a positive user experience. Traditional attempts include using a “Completely Automated Public Turing test to tell Computers and Humans Apart” (CAPTCHA). A CAPTCHA is a security mechanism that presents a challenge-response test designed to distinguish between human users and automated programs or bots. Typically a CAPTCHA requires a user to interpret distorted text, images, or audio clips that are difficult for machines to process accurately.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a system diagram for presenting a login challenge and using results of the login challenge as a label for unstructured data in accordance with some embodiments.

FIG. 2 illustrates a swim lane diagram for presenting a login challenge and using results of the login challenge as a label for unstructured data in accordance with some embodiments.

FIG. 3 illustrates a user interface for presenting a login challenge in accordance with some embodiments.

FIG. 4 illustrates machine learning engine for training and execution related to using labeling unstructured data based on results of a login challenge as training or testing labels in accordance with some embodiments.

FIG. 5 illustrates a flowchart showing a technique for presenting a login challenge and using results of the login challenge as a label for unstructured data in accordance with some embodiments.

FIG. 6 illustrates generally an example of a block diagram of a machine upon which any one or more of the techniques discussed herein may perform in accordance with some embodiments.

FIG. 7 illustrates a prompt workflow, in accordance with some embodiments.

### DETAILED DESCRIPTION

The systems and techniques described herein may be used to prevent unauthorized bot access while generating labeled training data for training a machine learning model. These systems and techniques leverage human cognitive abilities to both verify user authenticity and produce useful data annotations.

An example technique for authentication and data annotation includes receiving an authentication request (e.g., a login request) or a request for access to a resource at a user interface (e.g., from a user). In response, a portion of unstructured or non-structured data may be presented on the user interface. A prompt may be displayed to interact with the graphical interface by providing information regarding the unstructured data. For example, the user interface may query a user to select a particular type of data from within the unstructured data, type out information from the unstructured data, or the like. A user may be asked to provide a judgment about structured or unstructured data (e.g., confidence of the user in the authenticity of a document). The information provided by the user may be used to determine whether the authentication request originated from a human user rather than an automated system, and if so, validate the authentication request. The information provided may also be used as a label for the unstructured data, such as to train or retrain a machine learning model. The machine learning model may be trained or retrained to output structured information or a data type based on an input of unstructured data.

In response to a login request, a user interface may be presented including a portion of unstructured data. The unstructured data may comprise text, images, audio, or video lacking predefined labels or structure or with unknown labels or unknown structure. A user may be prompted to identify or interact with a specific element within the unstructured data. For example, when the unstructured data is an image, the user interface may instruct the user to identify or select an instance of a particular object. In other examples, when the unstructured data is a text passage, the user interface may direct the user to highlight a word or phrase matching certain criteria. Text, image, or other types of objects may be selected from a variety of documents used to verify identity during onboarding. Such documents may include articles of incorporation, business licenses, permits, tax forms, other entity organization forms, merger and acquisition materials, or the like. Some prompts ask users to interpret unstructured data such as names, contact information, information relating to ownership structure, the location of specific information in a form, or text requiring translation, and some prompts may request a judgment from the user. Such a judgment may include evaluations of consistency of formatting, completeness, logic, clarity, the credibility of objects, or the user’s confidence in the authenticity of a document. Some judgments may rely on intuition to be used to train a machine learning model. An example of such a judgment is a user confidence that the identification of an entity may be verified from a given document. For example, a user may provide a suspicion score. For example, a user may have a low confidence in the ability of a given document to validate ownership. Or the user may have low confidence in the legitimacy of an entity match. The user may suspect fraud. In these cases, the user may not be able to articulate why they feel this way about the document, but by capturing a suspicion score and training a model, false positives may be reduced and human intuition may be captured. The unstructured data may include partially structured data (e.g., data entered into a field), entirely unstructured data, unstructured data that is structured but unlabeled or of unknown structure, or the like.

A CAPTCHA system may use a response to a request for information related to unstructured data to verify that the requestor is a human and not a bot or other automated system. The CAPTCHA system may analyze user interactions with a user interface to verify that the login request was generated by a human rather than an automated system. This verification process may consider factors such as accuracy, speed, or pattern of user responses. When the CAPTCHA system determines the interactions indicate human behavior, the login request may be allowed to proceed. When the CAPTCHA system determines the interactions do not indicate human behavior, the login request may be prevented, redirected, stopped, etc. In the example where the CAPTCHA system determines the interactions do not indicate human behavior, a label created with the login request (e.g., identification of an element of unstructured data) may be discarded and not used for training a machine learning model.

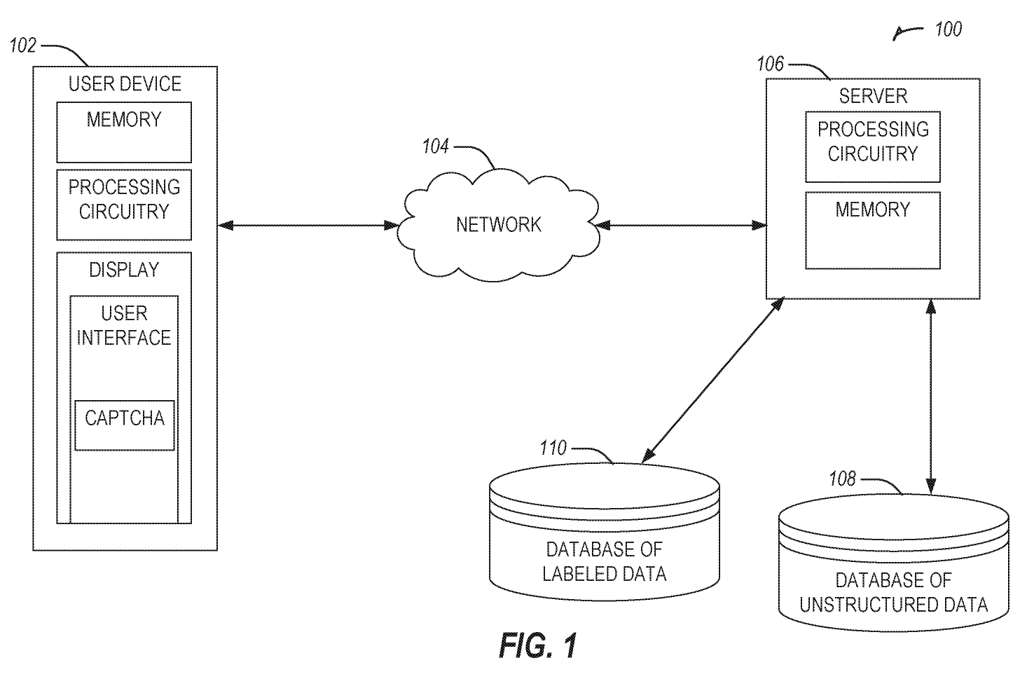

FIG. 1 illustrates a system diagram 100 for presenting a login challenge and using results of the login challenge as a label for unstructured data in accordance with some embodiments. The system diagram 100 illustrates a user device 102 in communication with a server 106 via a network 104 (e.g., the Internet). The server 106 may include or be in communication with a database of labeled data 110 or a database of unstructured data 108. In some examples, the database of labeled data 110 and the database of unstructured data 108 may be the same database.

The user device 102 may send a login request or other request for a resource via the network 104 to the server 106. The server 106 may, as part of an authentication or verification process, generate a CATPCHA to send to the user device 102. The CATPCHA may be sent to the user device 102 after authenticating user credentials received from the user device 102 or before. In some examples, the CATPCHA may be generated as a verification without other authentication or verification or separately from any other authentication or verification. For example, the CATPCHA is used as a verification that the user device 102 is being controlled by a human user rather than a bot.

The server 106 may include processing circuitry and memory to generate the CATPCHA. For example, the server 106 may be in communication with or include the database of unstructured data 108. The database of unstructured data 108 may include unstructured data, such as text, a document, a video, an audio file, etc. The unstructured data may be stored in the database of unstructured data 108 in portions compatible with generating a CAPTCHA (e.g., in portions, parts, or chunks), or may be stored as files or as received. The server 106 may retrieve unstructured data from the database of unstructured data 108, for example a document, a file, text, a portion of a document, etc. The server 106 may receive a portion of unstructured data ready for use as a CAPTCHA (e.g., as stored), or may portion received unstructured data into a portion for use as a CAPTCHA. The server 106 may prepare a CAPTCHA using unstructured data received from the database of unstructured data 108 by adding a request for information to the unstructured data. The request for information may include a request for an indication of identification of a type of document, a type of a portion of unstructured data (e.g., ownership information, name information, etc.), ownership structure information, an identification of a language of a portion of data in unstructured data, a name in unstructured data, a name of an entity present in unstructured data, or the like. As noted above, the prompt may ask for judgments about such items as the consistency of format, the user’s confidence in the authenticity of a document, the clarity with which objects are presented, etc.

In some examples, the server 106 may generate a CAPTCHA and store it at the server 106 or elsewhere before receiving a user request for login or a resource. In these examples, the CAPTCHA is ready for sending from the server 106 as soon as a user request is received.

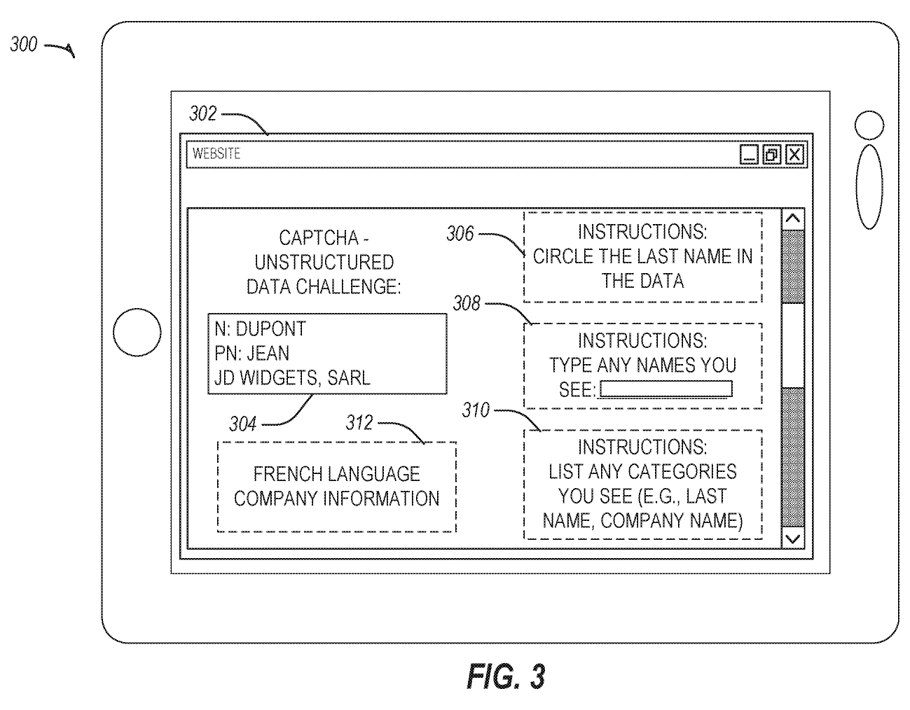

After the CAPTCHA has been generated at the server 106, the server may send the CAPTCHA to the user device 102. The user device 102 may include memory, processing circuitry, and a display. The display may present the CAPTCHA, received from the server 106, in a user interface. An example user interface is shown in FIG. 3 and described below.

A user of the user device 102 may provide information related to a request in the CAPTCHA, which may be sent to the server 106. The server 106 may store the information (e.g., after processing) in the database of labeled data 110, with or without the corresponding unstructured data. The database of labeled data 110 may include individually labeled data, collected labeled data (e.g., multiple users may label a single portion of unstructured data, in some examples with outliers discarded), verified labeled data (e.g., compared to previously labeled data, such as by a subject matter expert or via an original source of the data), or the like. The labeled data may be used to train a machine learning model to label unstructured data. In some examples, the labeled data may be used to onboard an original source of the data.

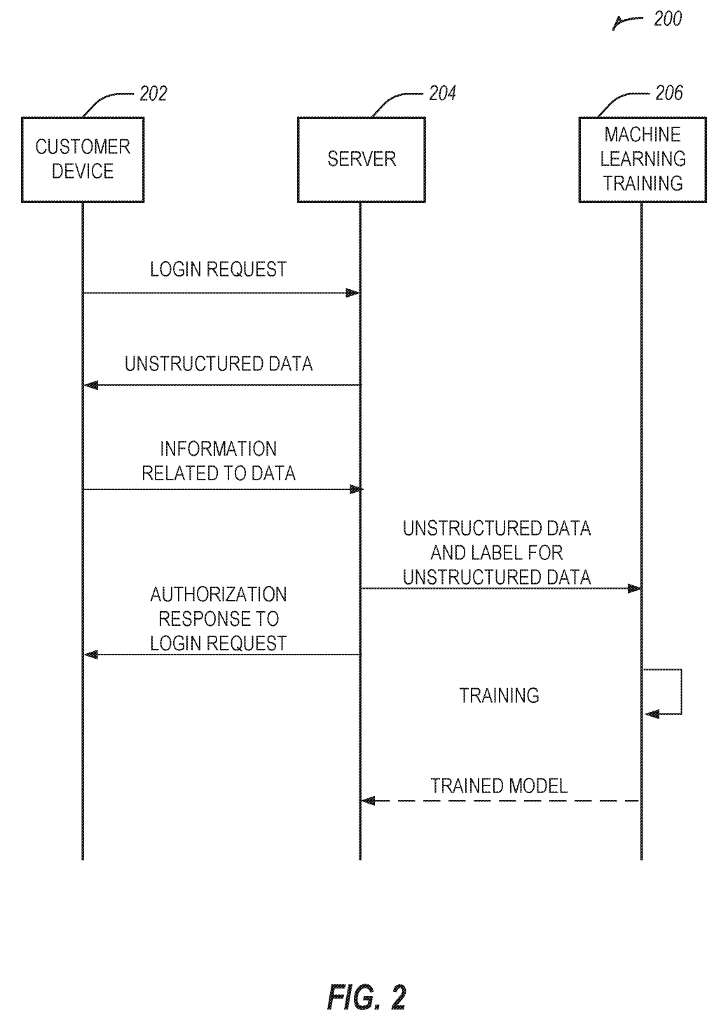

FIG. 2 illustrates a swim lane diagram 200 for presenting a login challenge and using results of the login challenge as a label for unstructured data in accordance with some embodiments. The swim lane diagram 200 illustrates interactions between and among a customer device 202, a server 204, and machine learning training processing circuitry 206.

The customer device 202 may initiate an interaction via a login request, which is sent to the server 204. The server 204 may send unstructured data to the customer device 202, for example in a CAPTCHA. The customer device 202 may respond to the server 204 with information related to the data (e.g., a label for a portion of the unstructured data). After a user submits a response, the response may be scored for certain metrics including speed of entry (how fast responses are entered once the user begins typing), speed to entry (how long before the user begins typing a response), accuracy, comprehensiveness of response, or error types or frequency. Scores against these metrics or the responses themselves, may be compared to one or more of the following: aggregated patterns of responses and measurements, known results (from backtesting), or third-party vendor output for functions such as OCR. The server 204 may identify a label for the unstructured data from the information and send the unstructured data and the label for the unstructured data to the machine learning training processing circuitry 206 for training a machine learning model. The machine learning training processing circuitry 206 may train the machine learning model using the label and the unstructured data. The server 204 may send an authorization response to the customer device 202 for the login request, for example based on authentication of customer credentials send by the customer device 202 and based on verification that a user of the customer device 202 is a human and not a bot based on the information sent to the server 204 for the unstructured data. The communications between the server 204 and the machine learning training processing circuitry 206 may occur at any time after the information related to the unstructured data is received at the server 204.

FIG. 3 illustrates a user interface 302 for presenting a login challenge in accordance with some embodiments. The user interface 302 may be presented on a user device 300. The user interface 302 illustrates a website that may be displayed in response to a request for a resource, such as a login request. The user interface 302 includes a component 304 including unstructured data, which may be related to a CAPTCHA. The user interface 302 may include other optional components, such as related to example instructions in components 306, 308, and 310 (other instructions may be used instead of or in addition to the illustrative instructions shown in FIG. 3). In some examples, only one of these components 306, 308, or 310 is shown in the user interface 302 at a time. For example, only one may be sent to a user. In some examples, the components 306, 308, and 310 may be shown sequentially (in any sequence, e.g., 308 to 310 to 306 or 310 to 306, etc.) to a user. In other examples, two or more of the components 306, 308, or 310 may presented in the user interface 302 (sequentially or at the same time).

The components 306, 308, and 310 include various example instructions for labeling the unstructured data in the component 304. For example, the component 306 illustrates instructions to circle a last name in the unstructured data (e.g., “Dupont” in component 304). The “circle” instruction may be performed with a touchscreen, a mouse, etc. The component 308 illustrates an instruction to type any names shown in the unstructured data (e.g., “Jean” and “Dupont” in component 304). The component 310 illustrates an instruction to list any categories shown in the unstructured data, with examples given of last name, company name, etc. (e.g., “first name”, “last name”, “company name” may be selected or listed, since a first name, last name, and company name are shown in the component 304). Examples such as those shown in the component 310 may be presented in any of the instructions, may be shown in response to a user request, or the like.

The user interface 302 may include an optional language query for a user to select a language for the CAPTCHA. The language query may be displayed before the CAPTCHA is sent, after a first and before a second CAPTCHA, generally on the website, or the like. When a language is selected or entered by a user, the CAPTCHA may present unstructured data in that language. For example, component 304 illustrates French language unstructured data because the user has selected French language.

The user interface 302 may include an optional context component 312. The context component 312 may show information corresponding to context of the unstructured data in the component 304. In the example of FIG. 3, the context component 312 indicates that the unstructured data in the component 304 is French language company information. This may be provided when known, for example to allow a user to label the unstructured data more accurately.

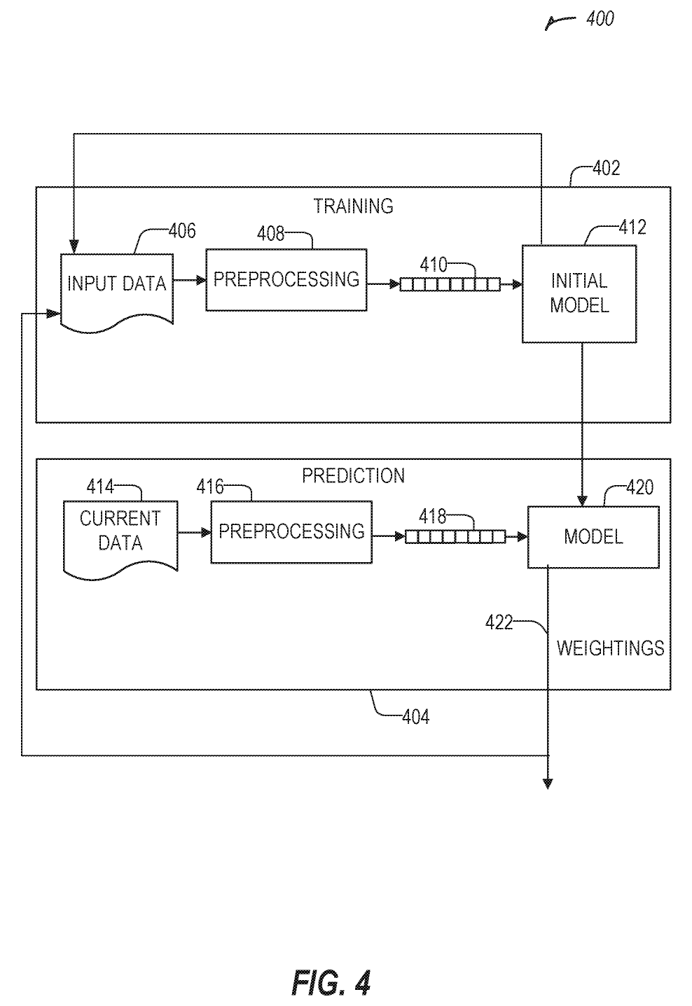

FIG. 4 illustrates machine learning engine for training and execution related to using labeling unstructured data based on results of a login challenge as training or testing labels in accordance with some embodiments. The machine learning engine may be deployed to execute at a mobile device (e.g., a cell phone) or a computer (e.g., a server). A system may calculate one or more weightings for criteria based upon one or more machine learning algorithms. FIG. 4 shows an example machine learning engine 400 according to some examples of the present disclosure.

Machine learning engine 400 uses a training engine 402 and a prediction engine 404. Training engine 402 uses input data 406, for example after undergoing preprocessing component 408, to determine one or more features 410. The one or more features 410 may be used to generate an initial model 412, which may be updated iteratively or with future labeled or unlabeled data (e.g., during reinforcement learning), for example to improve the performance of the prediction engine 404 or the initial model 412. An improved model may be redeployed for use.

The input data 406 may include unstructured data, such as a document (e.g., a PDF, a text file, a slideshow, a spreadsheet, a website, etc.), a string (e.g., text data), or other information. The unstructured data may include partially structured data (e.g., data entered into a field), entirely unstructured data, unstructured data that is structured but unlabeled or of unknown structure, or the like.

In the prediction engine 404, current data 414 (e.g., information received in a request, such as via an API, which may include a user, a use, a client, etc.) may be input to preprocessing component 416. In some examples, preprocessing component 416 and preprocessing component 408 are the same. The prediction engine 404 produces feature vector 418 from the preprocessed current data, which is input into the model 420 to generate one or more criteria weightings 422. The criteria weightings 422 may be used to output a prediction, as discussed further below.

The training engine 402 may operate in an offline manner to train the model 420 (e.g., on a server). The prediction engine 404 may be designed to operate in an online manner (e.g., in real-time, at a mobile device, on a wearable device, etc.). In some examples, the model 420 may be periodically updated via additional training (e.g., via updated input data 406 or based on labeled or unlabeled data output in the weightings 422) or based on identified future data, such as by using reinforcement learning to personalize a general model (e.g., the initial model 412) to a particular user.

Labels for the input data 406 may include an indication of identification of a type of document, a type of a portion of unstructured data (e.g., ownership information, name information, etc.), ownership structure information, an identification of a language of a portion of data in unstructured data, an entity name in unstructured data, an entity name present in unstructured data, or the like. A user may be asked to provide a judgment about structured or unstructured data (e.g., confidence of the user in the authenticity of a document). The labels may include a free text entered label, a drop down selected label, a shape input (e.g., a mouse drawn circle or square around a portion of unstructured data), a clicked on or selected portion of unstructured data, or the like.

The initial model 412 may be updated using further input data 406 until a satisfactory model 420 is generated. The model 420 generation may be stopped according to a specified criteria (e.g., after sufficient input data is used, such as 1,000, 10,000, 100,000 data points, etc.) or when data converges (e.g., similar inputs produce similar outputs).

The specific machine learning algorithm used for the training engine 402 may be selected from among many different potential supervised or unsupervised machine learning algorithms. Examples of supervised learning algorithms include artificial neural networks, Bayesian networks, instance-based learning, support vector machines, decision trees (e.g., Iterative Dichotomiser 3, C9.5, Classification and Regression Tree (CART), Chi-squared Automatic Interaction Detector (CHAID), and the like), random forests, linear classifiers, quadratic classifiers, k-nearest neighbor, linear regression, logistic regression, and hidden Markov models. Examples of unsupervised learning algorithms include expectation-maximization algorithms, vector quantization, and information bottleneck method. Unsupervised models may not have a training engine 402. In an example embodiment, a regression model is used and the model 420 is a vector of coefficients corresponding to a learned importance for each of the features in the vector of features 410, 418. A reinforcement learning model may use Q-Learning, a deep Q network, a Monte Carlo technique including policy evaluation and policy improvement, a State-Action-Reward-State-Action (SARSA), a Deep Deterministic Policy Gradient (DDPG), or the like.

Once trained, the model 420 may output entity verification guidance such as information on where to locate entity-verifying information on a particular form, how to use the information on a given form to generate fewer false positives, etc. The model 420 may output an algorithm for developing an overall score of entity verification confidence, or an algorithm for scoring various types of fraud that may be in evidence in a given form. The trained model 420 may output a technique for enhanced form transcription or a database of transcribed names and contact information.

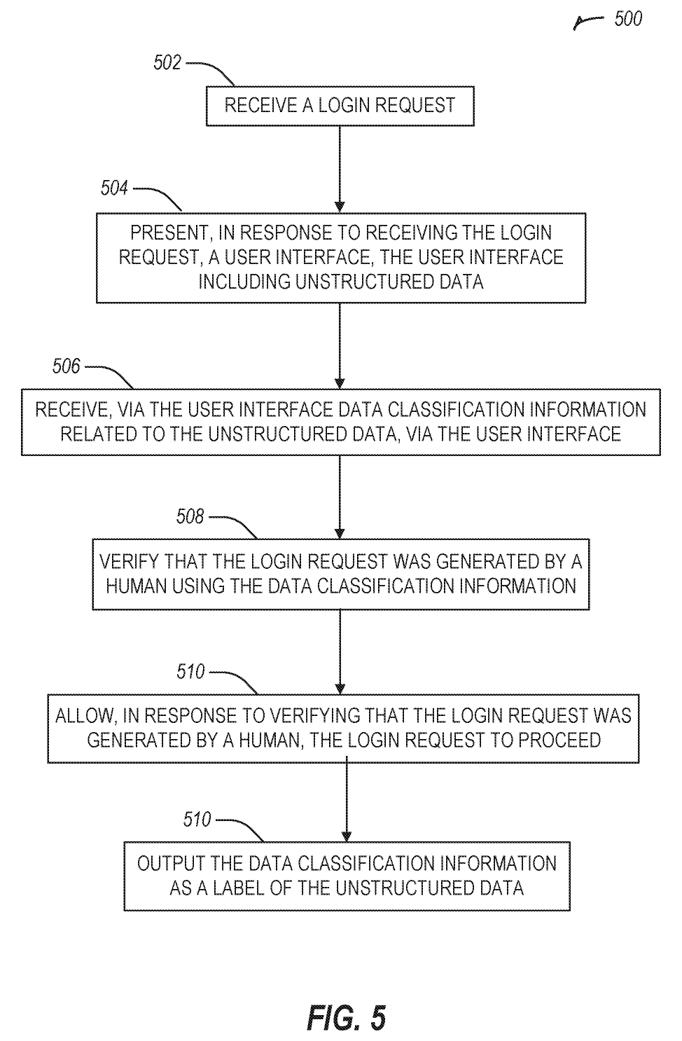

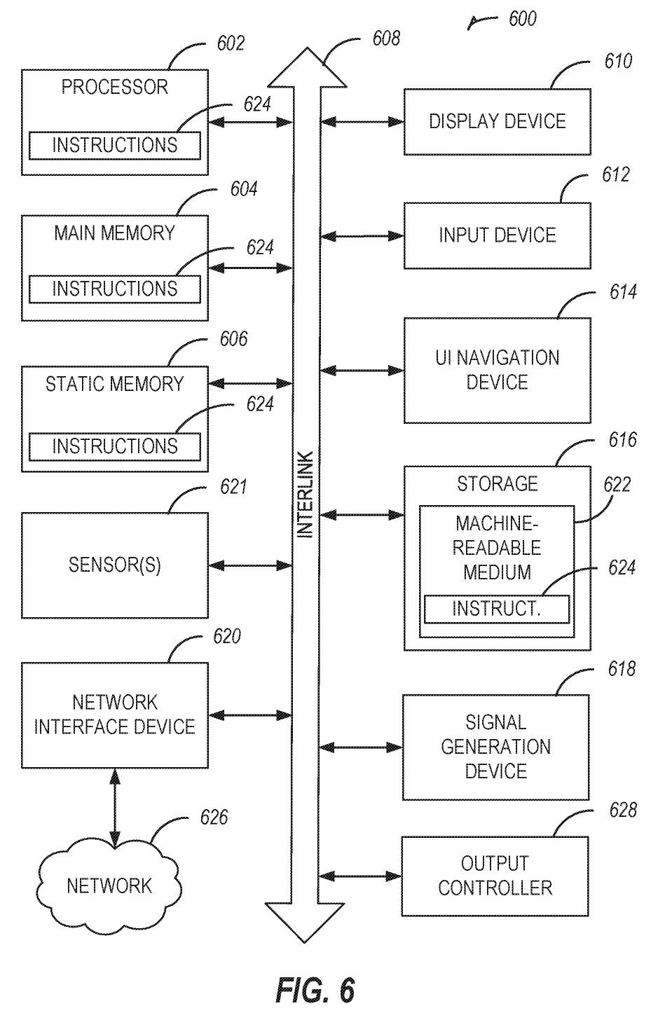

FIG. 5 illustrates a flowchart showing a technique 500 for presenting a login challenge and using results of the login challenge as a label for unstructured data in accordance with some embodiments. In an example, operations of the technique 500 may be performed by processing circuitry, for example by executing instructions stored in memory. The processing circuitry may include a processor, a system on a chip, or other circuitry (e.g., wiring). For example, the technique 500 may be performed by processing circuitry of a device (or one or more hardware or software components thereof), such as those illustrated and described with reference to FIG. 6.

The technique 500 includes an operation 502 to receive a login request. In an example, the login request is for an employee of an entity. In this example, the unstructured data may be data confidential to the entity.

The technique 500 includes an operation 504 to present, in response to receiving the login request, a user interface, the user interface including unstructured data. The unstructured data may be derived from a document, an image, a video, audio, text, etc. In an example, the login request is for an employee of an entity, and the unstructured data includes documentation of an unknown origin, information from a third party (e.g., to the entity), an international document, information indicative of a local or a global ownership structure, articles of incorporation, business licenses, permits, tax forms, other entity organization forms, merger and acquisition information, lease agreements, stock certificates, international variants of these, or the like. Operation 504 may include presenting a language query. In this example, a response to the language query may be used to select the unstructured data, the response and the unstructured data sharing a same language. Operation 504 may include presenting context for the unstructured data. The context may include a location of origin of the unstructured data, a submitting entity, a purpose for the unstructured data, or the like. The context may be presented in response to determining that a set of labels received for the unstructured data is not satisfactory. In an example, a set of labels is not satisfactory when at least two labels in the set of labels disagree. In another example, a set of labels is not satisfactory when none of the labels of the set of labels agree. In yet another examples, a set of labels is not satisfactory when fewer than a threshold number of labels in the set of labels agree. Operation 504 may include presenting the unstructured data and a query asking for the data classification information, and receiving in response a typed response via a data entry field of the user interface. Operation 504 may include presenting the unstructured data and a query asking where in the unstructured data a particular information type is located, and receiving in response a mouse input on the user interface indicating a location in the unstructured data. The mouse input may include a shape drawn around the location, a click on a location of the information, an underline of the location, a line through the location, or the like.

The technique 500 includes an operation 506 to receive, via the user interface data classification information related to the unstructured data, via the user interface. The data classification information may include identification of a type of document or an ownership structure of the unstructured data. Some prompts may ask users to interpret unstructured data such as names, contact information, information relating to ownership structure, the location of specific information in a form, or text requiring translation, and some prompts may require judgments. Such judgments may include evaluations of consistency of formatting, completeness, logic, clarity, the credibility of objects, or the user’s confidence in the authenticity of a document. The unstructured data may be generated using a machine learning trained model based on a document. The data classification information may include a name or an entity present in the unstructured data. In some examples, the data classification information may include a name of a company, a name of a person, an address, a signature line, or the like. The data classification information may include a transcription of the unstructured data, a location of a portion of the unstructured data within a document, a translation of the unstructured data, an indication of a data type of the unstructured data, or the like. The data classification information may include a judgment of the unstructured data based on at least one of an evaluation of consistency of formatting of the unstructured data, completeness of the unstructured data, or a clarity of the unstructured data. The judgment may be a judgment based on overall appearance of the unstructured data, for example a user’s “instinct” about whether the data is potentially faked.

The technique 500 includes an operation 508 to verify that the login request was generated by a human using the data classification information. The technique 500 includes an operation 510 to allow, in response to verifying that the login request was generated by a human, the login request to proceed. The technique 500 may include an operation to output the data classification information as a label of the unstructured data. The label or the unstructured data used to train a machine learning model.

The technique 500 may include training or retraining the machine learning model using the label or a second label and for the unstructured data based on a second login request by a different user. Multiple labels may be used, such as by selecting a label based on a most selected option among the multiple labels. The machine learning model may be trained using a validity metric corresponding to a speed of entry of the data classification information after the unstructured data is presented in the user interface, the validity metric indicating a likelihood that the data classification information is accurate. The technique 500 may include identifying a pattern of types of documents based on labels of a set of unstructured data. The technique 500 may include sanitizing the unstructured data before presenting in the user interface.

FIG. 6 illustrates generally an example of a block diagram of a machine 600 upon which any one or more of the techniques (e.g., methodologies) discussed herein may perform in accordance with some embodiments. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a display unit 610, an alphanumeric input device 612 (e.g., a keyboard), and a user interface (UI) navigation device 614 (e.g., a mouse). In an example, the display unit 610, alphanumeric input device 612 and UI navigation device 614 may be a touch screen display. The machine 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a machine readable medium 622 that is non-transitory on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

While the machine readable medium 622 is illustrated as a single medium, the term “machine readable medium” may include a single medium or multiple media (e.g., a centralized or distributed database, or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software.

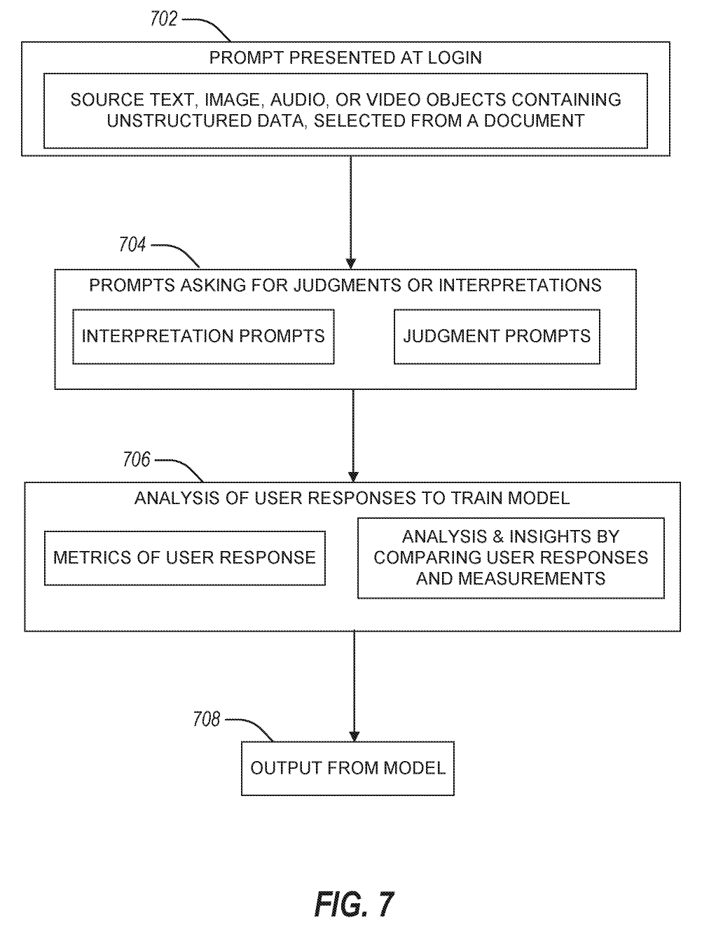

FIG. 7 illustrates a prompt workflow, in accordance with some embodiments. FIG. 7 includes an operation 702 to present a prompt at login to a user. The prompt may include source text, image, audio, or video objects containing unstructured data, selected from a document, or the like. For example, a document may include articles of incorporation, business licenses, permits, tax forms, other entity organization forms, merger and acquisition information, lease agreements, stock certificates, international variants of the above, or the like.

The prompt workflow includes an operation 704 to provide a prompt asking for a judgment or an interpretation. A judgment prompt may include consistency – evaluate formatting and image resolution consistency, completeness – evaluate completeness of form, logic – evaluate coherence of text objects, clarity – evaluate to what extent objects are clear or blurred, object integrity – evaluate credibility of objects such as watermarks, confidence – evaluate the user’s confidence in the authenticity of materials, or the like. An interpretation prompt may include transcription - write out text appearing in an object (text can be names, contact information, and information relating to ownership structure), location - indicate where certain types of information can be found, translation - where information is encoded in a language other than English, identify type of information, or the like.

The prompt workflow includes an operation 706 to analyze user responses to train a model. The model may be trained using metrics of user responses or analysis and insights by comparing user responses and measurements. For example, metrics may include speed of entry, speed to entry, accuracy, comprehensiveness, error types, error frequency, or the like. Analysis may include aggregated patterns of user responses or measurements, results from back testing, third-party vendor output for functions such as OCR, or the like.

The prompt workflow includes an operation 708 to output from a trained model information such as entity verification guidance, entity verification confidence, enhanced fraud detection, enhanced form transcription, or the like.

The following, non-limiting examples, detail certain aspects of the present subject matter to solve the challenges and provide the benefits discussed herein, among others.

Example 1 is a method comprising: receiving a login request; presenting, in response to receiving the login request, a user interface, the user interface including unstructured data; receiving, via the user interface, data classification information related to the unstructured data, via the user interface; verifying, using processing circuitry, that the login request was generated by a human using the data classification information; allowing, in response to verifying that the login request was generated by a human, the login request to proceed; and outputting, using the processing circuitry, the data classification information as a label of the unstructured data, the label and the unstructured data used to train a machine learning model.

In Example 2, the subject matter of Example 1 includes, wherein the data classification information includes identification of a type of document or an ownership structure of the unstructured data.

In Example 3, the subject matter of Examples 1–2 includes, retraining the machine learning model using the label and a second label and for the unstructured data based on a second login request by a different user.

In Example 4, the subject matter of Examples 1–3 includes, wherein the login request is for an employee of an entity, and wherein the unstructured data is data confidential to the entity.

In Example 5, the subject matter of Examples 1–4 includes, wherein presenting the user interface includes presenting a language query, and wherein a response to the language query is used to select the unstructured data, the response and the unstructured data sharing a same language.

In Example 6, the subject matter of Examples 1–5 includes, wherein the data classification information includes at least one of a transcription of the unstructured data, a location of a portion of the unstructured data within a document, a translation of the unstructured data, or an indication of a data type of the unstructured data.

In Example 7, the subject matter of Examples 1–6 includes, wherein the data classification information includes a judgment of the unstructured data based on at least one of an evaluation of consistency of formatting of the unstructured data, completeness of the unstructured data, or a clarity of the unstructured data.

In Example 8, the subject matter of Examples 1–7 includes, wherein to train the machine learning model includes using a validity metric corresponding to a speed of entry of the data classification information after the unstructured data is presented in the user interface, the validity metric indicating a likelihood that the data classification information is accurate.

In Example 9, the subject matter of Examples 1–8 includes, wherein presenting the user interface includes presenting the unstructured data and a query asking for the data classification information, and further comprising receiving a typed response via a data entry field of the user interface.

In Example 10, the subject matter of Examples 1–9 includes, wherein presenting the user interface includes presenting the unstructured data and a query asking where in the unstructured data a particular information type is located, and further comprising receiving a mouse input on the user interface indicating a location in the unstructured data.

Example 11 is at least one non-transitory machine-readable medium including instructions, which when executed by processing circuitry, causes the processing circuitry to perform operations to: receive a login request; present, in response to receiving the login request, a user interface, the user interface including unstructured data; receive, via the user interface, data classification information related to the unstructured data, via the user interface; verify that the login request was generated by a human using the data classification information; allow, in response to verifying that the login request was generated by a human, the login request to proceed; and output the data classification information as a label of the unstructured data, the label and the unstructured data used to train a machine learning model.

In Example 12, the subject matter of Example 11 includes, wherein the data classification information includes identification of a type of document or an ownership structure of the unstructured data.

In Example 13, the subject matter of Examples 11–12 includes, wherein the operations further cause the processing circuitry to retrain the machine learning model using the label and a second label and for the unstructured data based on a second login request by a different user.

In Example 14, the subject matter of Examples 11–13 includes, wherein the login request is for an employee of an entity, and wherein the unstructured data is data confidential to the entity.

In Example 15, the subject matter of Examples 11–14 includes, wherein to present the user interface, the operations further cause the processing circuitry to present a language query, and wherein a response to the language query is used to select the unstructured data, the response and the unstructured data sharing a same language.

In Example 16, the subject matter of Examples 11–15 includes, wherein the data classification information includes at least one of a transcription of the unstructured data, a location of a portion of the unstructured data within a document, a translation of the unstructured data, or an indication of a data type of the unstructured data.

In Example 17, the subject matter of Examples 11–16 includes, wherein the data classification information includes a judgment of the unstructured data based on at least one of an evaluation of consistency of formatting of the unstructured data, completeness of the unstructured data, or a clarity of the unstructured data.

In Example 18, the subject matter of Examples 11–17 includes, wherein to train the machine learning model includes using a validity metric corresponding to a speed of entry of the data classification information after the unstructured data is presented in the user interface, the validity metric indicating a likelihood that the data classification information is accurate.

In Example 19, the subject matter of Examples 11–18 includes, wherein to present the user interface, the operations further cause the processing circuitry to present the unstructured data and a query asking for the data classification information, and wherein the operations further cause the processing circuitry to receive a typed response via a data entry field of the user interface.

In Example 20, the subject matter of Examples 11–19 includes, wherein to present the user interface, the operations further cause the processing circuitry to present the unstructured data and a query asking where in the unstructured data a particular information type is located, and wherein the operations further cause the processing circuitry to receive a mouse input on the user interface indicating a location in the unstructured data.

Example 21 is at least one machine-readable medium including instructions that, when executed by processing circuitry, cause the processing circuitry to perform operations to implement of any of Examples 1–20.

Example 22 is an apparatus comprising means to implement of any of Examples 1–20.

Example 23 is a system to implement of any of Examples 1–20.

Example 24 is a method to implement of any of Examples 1–20.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

What is claimed is:

1. A method comprising:
receiving a login request;
presenting, in response to receiving the login request, a user interface, the user interface including unstructured data;
receiving, via the user interface, data classification information related to the unstructured data, via the user interface;
verifying, using processing circuitry, that the login request was generated by a human using the data classification information;
allowing, in response to verifying that the login request was generated by a human, the login request to proceed; and
outputting, using the processing circuitry, the data classification information as a label of the unstructured data, the label and the unstructured data used to train a machine learning model.

2. The method of claim 1, wherein the data classification information includes identification of a type of document or an ownership structure of the unstructured data.

3. The method of claim 1, further comprising retraining the machine learning model using the label and a second label and for the unstructured data based on a second login request by a different user.

4. The method of claim 1, wherein the login request is for an employee of an entity, and wherein the unstructured data is data confidential to the entity.

5. The method of claim 1, wherein presenting the user interface includes presenting a language query, and wherein a response to the language query is used to select the unstructured data, the response and the unstructured data sharing a same language.

6. The method of claim 1, wherein the data classification information includes at least one of a transcription of the unstructured data, a location of a portion of the unstructured data within a document, a translation of the unstructured data, or an indication of a data type of the unstructured data.

7. The method of claim 1, wherein the data classification information includes a judgment of the unstructured data based on at least one of an evaluation of consistency of formatting of the unstructured data, completeness of the unstructured data, or a clarity of the unstructured data.

8. The method of claim 1, wherein to train the machine learning model includes using a validity metric corresponding to a speed of entry of the data classification information after the unstructured data is presented in the user interface, the validity metric indicating a likelihood that the data classification information is accurate.

9. The method of claim 1, wherein presenting the user interface includes presenting the unstructured data and a query asking for the data classification information, and further comprising receiving a typed response via a data entry field of the user interface.

10. The method of claim 1, wherein presenting the user interface includes presenting the unstructured data and a query asking where in the unstructured data a particular information type is located, and further comprising receiving a mouse input on the user interface indicating a location in the unstructured data.

11. At least one non-transitory machine-readable medium including instructions, which when executed by processing circuitry, causes the processing circuitry to perform operations to:
receive a login request;
present, in response to receiving the login request, a user interface, the user interface including unstructured data;
receive, via the user interface, data classification information related to the unstructured data, via the user interface;
verify that the login request was generated by a human using the data classification information;
allow, in response to verifying that the login request was generated by a human, the login request to proceed; and
output the data classification information as a label of the unstructured data, the label and the unstructured data used to train a machine learning model.

12. The at least one non-transitory machine-readable medium of claim 11, wherein the data classification information includes identification of a type of document or an ownership structure of the unstructured data.

13. The at least one non-transitory machine-readable medium of claim 11, wherein the operations further cause the processing circuitry to retrain the machine learning model using the label and a second label and for the unstructured data based on a second login request by a different user.

14. The at least one non-transitory machine-readable medium of claim 11, wherein the login request is for an employee of an entity, and wherein the unstructured data is data confidential to the entity.

15. The at least one non-transitory machine-readable medium of claim 11, wherein to present the user interface, the operations further cause the processing circuitry to present a language query, and wherein a response to the language query is used to select the unstructured data, the response and the unstructured data sharing a same language.

16. The at least one non-transitory machine-readable medium of claim 11, wherein the data classification information includes at least one of a transcription of the unstructured data, a location of a portion of the unstructured data within a document, a translation of the unstructured data, or an indication of a data type of the unstructured data.

17. The at least one non-transitory machine-readable medium of claim 11, wherein the data classification information includes a judgment of the unstructured data based on at least one of an evaluation of consistency of formatting of the unstructured data, completeness of the unstructured data, or a clarity of the unstructured data.

18. The at least one non-transitory machine-readable medium of claim 11, wherein to train the machine learning model includes using a validity metric corresponding to a speed of entry of the data classification information after the unstructured data is presented in the user interface, the validity metric indicating a likelihood that the data classification information is accurate.

19. The at least one non-transitory machine-readable medium of claim 11, wherein to present the user interface, the operations further cause the processing circuitry to present the unstructured data and a query asking for the data classification information, and wherein the operations further cause the processing circuitry to receive a typed response via a data entry field of the user interface.

20. The at least one non-transitory machine-readable medium of claim 11, wherein to present the user interface, the operations further cause the processing circuitry to present the unstructured data and a query asking where in the unstructured data a particular information type is located, and wherein the operations further cause the processing circuitry to receive a mouse input on the user interface indicating a location in the unstructured data.
